(19) United States
(12) Patent Application Publication
(10) Pub. No.: US 2014/0260644 A1
(43) Pub. Date: Sep. 18, 2014

(54) Modular Systems for Piezoresistive Transducers

(71) Applicant: Sensonetics, Inc., Huntington Beach, CA (US)

(72) Inventor: Mark Russell Sahagen, Huntington Beach, CA (US)

(73) Assignee: Sensonetics, Inc., Huntington Beach, CA (US)

(21) Appl. No.: 13/831,597

(22) Filed: Mar. 15, 2013

(51) Int. Cl. G01L 19/00; G01L 9/00

(52) U.S. Cl. CPC G01L 19/0092; G01L 9/0052
USPC 73/708; 73/727; 374/143

(57) ABSTRACT

The present invention relates to a modular system for sensing pressure and/or temperature. The system uses a piezoresistive transducer that contacts a fluid, a transducer housing for the piezoresistive transducer, a conductor tube, a transition housing, a cable, an adapter housing, a flex conductor, an electronic housing, wherein the transducer housing, the conductor tube, the transition housing, the cable, the adapter housing, the flex conductor, and the electronic housing protect a conductive path for electrical signal(s) from the piezoresistive transducer to the electronic housing. The system may use cable to couple the transition housing to the adapter housing sufficient in length to keep the transducer at the site of interest and the more sensitive electronic circuits away from high pressure, temperature, and/or RF/EMI environments such as that associated with down-hole drilling. In another embodiment, some or all the conductive path is multilayered wire.

### BACKGROUND

The present invention relates to a system for measurement of fluid properties such as pressure and/or temperature. More particularly, the present invention relates to a modular system with a piezoresistive pressure transducer that is suitable for high pressure and/or high temperature environments.

Piezoresistive pressure transducers have been used in the aerospace and automotive industries. Some applications include process monitoring, rotating machinery monitoring and testing, and jet and gas turbine engine controls.

One environment that led to certain features of my system is oil exploration. In the past, scientists developed several techniques to help detect oil. Magnetic survey is the oldest technique and uses magnetometers to detect minute variation in the rock. Sedimentary rock, potentially oil bearing are non-magnetic while igneous are magnetic. Gravity surveys detect minute variations in the gravity field, which differentiates sedimentary rock (maybe with oil) from basement rock. Seismic surveying involves sending vibrations into the earth and detecting the reflected energy to image the subsurface geology. Although helpful to ascertain the subsurface geology, one must drill a hole in a high temperature and pressure environment to prove where there is oil.

Down-hole oil exploration and production require accurate pressure and temperature sensing of corrosive, abrasive fluid in the drill hole. The temperatures can be high (e.g., 500 F and greater), because they can involve heaters designed to heat up shale oil deposits at high pressures 2,000-5,000 feet below the surface of the earth. Inductance heaters also used to heat shale oil for extraction from the bore hole may produce electromagnetic interference (EMI). The fluid monitored may be crude shale oil, a mixture of rock, oil, and water.

The inventor recognized that conventional alloys of steel and stainless steel exposed to such media are readily abraded and degraded and high pressure, high temperature, and EMI cause other obstacles to getting reliable pressure and temperature measurements.

The inventor recognized a piezoresistive pressure transducer might offer advantages in such an environment due to their size, absence of moving parts and potential for sensitivity. A piezoresistive pressure transducer is a pressure force collector diaphragm having one or more piezoresistive elements mounted thereon. The diaphragm with the piezoresistive elements is typically placed in a pressure cell of some type which maintains a low pressure or vacuum on one side of the diaphragm and allows the external medium under pressure to contact the other side of the diaphragm. A voltage is placed across the piezoresistive element(s) and as the diaphragm bends in response to pressure changes, a resistance change in the piezoresistive element(s) results in a change in the current flowing through the piezoresistive element(s).

However, the inventor recognized that a piezoresistive transducer would require an overall system that could survive an extreme environment that might include at least one of the following: high pressure, high temperature, abrasive fluid, and corrosive fluid, all while producing monitoring signals that accurately indicate the fluid pressure and temperature.

### SUMMARY OF INVENTION

The present invention relates to a modular system for sensing fluid properties, comprising a piezoresistive transducer that contacts a fluid, a transducer housing for the piezoresistive transducer, a conductor tube, a transition housing, a cable, an adapter housing, a flex conductor, an electronic housing, wherein the transducer housing, the conductor tube, the transition housing, the cable, the adapter housing, the flex conductor, and the electronic housing protect a conductive path for electrical signal(s) from the piezoresistive transducer to the electronic housing. In an embodiment the system includes one or more of the following circuits in the conductive path to increase the accuracy of the electrical signals indicating pressure and/or temperature: a digital compensation circuit, a pressure circuit, and a temperature circuit. In a preferred embodiment, the cable coupling the transition housing to the adapter housing is sufficient in length to keep the electronic housing away from the high pressure, temperature, and/or RF/EMI such as that usually associated in down-hole drilling. In another embodiment, part of the conductive path multilayered wire includes a core conductor encapsulated in ceramic powder coating and braided fiberglass insulation.

### BRIEF DESCRIPTION OF THE DRAWINGS

FIG. 1 illustrates an embodiment of the system of present invention.

FIG. 2 is a cross-section through the embodiment shown in FIG. 1.

FIG. 3 is a cross-section through the protective nose cone at the pressure and temperature receiving end of the embodiment shown in FIG. 2.

FIG. 4 is a cross-section through an embodiment of the pressure and temperature sensing cell assembly of the system.

FIG. 5A illustrates an isometric view of the hexagonal shaped diaphragm with piezoresistive elements and electrical contacts.

FIG. 5B illustrates a top view of the hexagonal shaped diaphragm with piezoresistive elements and electrical contacts.

FIG. 6A illustrates an isometric view of the circular shaped diaphragm with piezoresistive elements and electrical contacts.

FIG. 6B illustrates a top view of the circular shaped diaphragm with piezoresistive elements and electrical contacts.

FIG. 7 is a schematic of the circuit for sensing pressure and temperature with resistive thermal compensation.

FIG. 8A illustrates an end view of the pressure cell base of the system.

FIG. 8B illustrates a cross-section of the pressure cell base of the system.

FIG. 8C illustrates an isometric of the pressure cell base of the system.

FIG. 9A illustrates a perspective of a multilayered wafer with multiple diaphragms before dicing.

FIG. 9B illustrates a cross-section of the multilayered wafer.

FIG. 10A illustrates an end view of the header of the system.

FIG. 10B illustrates a cross-section of the header of the system.

FIG. 10C illustrates an isometric of the header of the system.

FIG. 11 is a cross-sectional view of the details in the lower part of the transducer housing shown in FIG. 2.

FIG. 12 is a cross-sectional view of the details in the upper part of the transducer housing shown in FIG. 2.

FIG. 13 illustrates the cross-sectional of the transition housing from Ml cable to the multilayered wire.

FIG. 14 illustrates an embodiment of a multilayered wire suitable for use in the conductive path of the system.

FIG. 15 illustrates embodiments of electronics housing and RFI/EMI filter housing.

FIG. 16A is a partial isometric view of the RFI/EMI filter assembly.

FIG. 16B is an end view of the RFI/EMI filter assembly.

FIG. 16C is a cross-sectional view of the RFI/EMI filter assembly.

FIG. 17 is a cross-sectional view of the Ml cable and K-type thermocouple.

### DETAILED DESCRIPTION OF THE PREFERRED EMBODIMENTS

The following description includes the best mode of carrying out the invention, illustrates the principles of the invention, uses illustrative values, and should not be taken in a limiting sense. The scope of the invention is determined by reference to the claims. Each part or step is assigned its own number in the specification and drawings. The drawings are not to scale and do not reflect the relative thickness of any of the layers.

FIG. 1 illustrates an embodiment of the system of the present invention. The modular system 10 includes a transducer housing 16 coupled by a conductor tube 26 to a transition housing 33. A cable 38 (e.g., 2,000-5,000 feet) couples the transition housing 33 to an adapter housing 49. A braided flex 48 couples the adapter housing 49 to an electronic housing 61. Swage lock fittings 24 and 28, adjacent adapter rings 22 and 30, are threaded onto male bolts (not shown) to secure the conductor tube 26 to the transducer housing 16 and the transition housing 33. Similarly, swage lock fitting 36 is threaded onto a male bolt (not shown) adjacent adapter ring 34 to secure the cable 38 to the transition housing 33. A crimped neck 40 secures the other end of the cable 38 to the adapter housing 49. As shown the adapter housing 49 includes a cable soft lead male adapter 42 and a cable soft lead female adapter 44. A crimped sleeve 47 secures a flex conductor 48, preferably braided flex, to the adapter housing 49. It should be noted that flex conductor 48 is preferably flexible, but could be more rigid as long as the adapter housing 49 and electronics housing 61 are connected. A crimped sleeve 50 secures the other end of the braided flex 48 to a mating connector cup 52. K-type thermocouple wires 45 extend from adapter housing 49 to a pressure signal cable 66. A conduit fitting 64 is attached to the adapter housing 61. A temperature signal cable 65 extends from the conduit fitting 64. Finally, the transducer housing 16 has a protective cone 12 with a port 11 (FIG. 2). The protective cone 12, the housings 16, 20, 33, 49, and 61, the swage lock fittings 24, 28, and 36, the conductor tube 26, the cable 38, the crimped sleeves 40, 47, and 50, the braided flex 48, and the conduit fitting 64 are preferably of a non-corrosive metal such as stainless steel (e.g., SS Type 316L).

FIG. 2 is a cross-section through the embodiment shown in FIG. 1. As shown in FIG. 2, the transducer housing 16 is attached to a protective cone 12 with internal threads for attachment to the transducer housing 16 and a port 11 (FIG. 3). The fluid also referred to as media (e.g., oil, water, etc.) entering the port 11 has a temperature and exerts pressure on the piezoresistive pressure transducer 13. As will be explained in detail below, the fluid pressure flexes the diaphragm 72 (FIG. 4), which has piezoresistive elements which change in resistance producing a change in an electrical signal from the piezoresistive pressure transducer 13.

The transducer lower housing 16 contains an adapter ring 14. Adapter ring 18 is between lower housing 16 and upper housing 20. Both adapter rings 14 and 18 are resistance spot welded to the housings and integral or welded to the secured headers 15 and 19 that support the Ni wires (e.g., wire 17). The wires (e.g., wire 17) can withstand high temperatures (e.g., greater than 500 F). Details on how to make one embodiment of the wire 17 is discussed in connection with FIG. 14. The preferably Ni wire 21 is a continuation of the wire 17 and exits the upper housing 20 through an adapter ring 22, the swage lock fitting 24, and into the conductor tube 26. The Ni wire 21 continues through the conductor tube 26 and into the transition housing 33 through the swage lock fitting 28 and the adapter ring 30 where it is welded by a resistance weld 32 securing to the Ml Ni wire 34. The Ml Ni wire 34 proceeds through the adapter ring 35 and the swage lock fitting 36 and into the cable 38.

The cable 38 may be lengthy (e.g., 1,000 to 5,000 feet). It could be more or less, and it is not the cable length that matters, but the arrangement to keep the sensitive electronics in the housing 61 (FIG. 2) out of an extreme environment (e.g., high fluid temperatures in down-hole drilling) where the transducer must be located to sense the fluid properties. One embodiment of the cable 38 is conventional Ml cable with 8 insulated conductors (e.g., Ml Ni wire 34), which may be further insulated in the cable 38. A solder joint 41 attaches the Ml Ni wire 34 to a soft lead 43, attached at the opposite end to a multilayered wire 150 (FIG. 14) by a solder joint 46. In an embodiment, the soft lead 43 is stranded Teflon insulated color coated wire which is encapsulated by a resin in the soft lead adapter 42. The soft lead 43 makes it easier to field assembly this part of the system. Braided flex 48 houses the multilayered wire 150 (or Ml Ni wire) from the crimped sleeve 47 to the crimped sleeve 50 to wires (e.g., wire 51) to a mating connector solder cup 52, which is attached to a mating connector 53, which is secured preferably to an 8-pin connector 54.

Individual wires (e.g., wire 55) connect the some of the pins of the 8-pin connector 54 to a pressure circuit 56 and a temperature circuit 57. Each circuit is adjustable by screws accessible on the walls of the electronic housing 61. The wires connect the 8-pin connector 54 to a digital compensation circuit 69, which has an offset resistor 59. A suitable digital compensation circuit is described in U.S. Provisional Application No. 61/683,145, Digital Compensated 4 to 20 mA Current Loop-Powered Pressure and Temperature Transmitters, filed on Aug. 14, 2012, assigned to Sensonetics, Inc., and incorporated by reference herein in its entirety.

A filter board assembly 60, including a printed circuit board 62, filters RF/EMI noise. A suitable pressure circuit 56, temperature circuit 57, compensation circuit 69, and filter board assembly 60 is available from Sensonetics, Inc., 15402 Electronic Lane, Huntington Beach, Calif. 92649. K-type thermocouple wires 45 are attached to the Ml Ni wire and secured to the pressure signal cable 66. In an embodiment, the K-type thermocouple wires are integral part of the cable 38, and terminate where the cable 38 exits from crimped sleeve 40. Finally, the temperature signal cable 65 and pressure signal cable 66 is connected to a computer for display, storage, and any data processing.

FIG. 3 is a cross-sectional view of a protective cone 12 at the pressure and temperature receiving end that could be used an alternative to the cone 12 shown in FIG. 2. The arrow pointing up indicates the general direction of the fluid into the port 11. This port 11, of course, is the entrance for fluid whose pressure and/or temperature is being sensed.

FIG. 4 is a cross-sectional view of an embodiment of the pressure and temperature sensing cell assembly of the system. As shown, the pressure and temperature cell assembly 71 includes a pressure sensor assembly of an overall cylindrical shape. The cross-sectional in FIG. 4 represents a section through the axis of the cylindrical package. Alternatively, rectangular, hexagonal or alternate shaped packages may be employed.

More specifically, the pressure sensor assembly includes a sapphire force collector diaphragm 72 mounted on a pressure cell base 74. The pressure cell base 74 is also referred to as a ceramic cell. Thin film piezoresistive elements are deposited on a first major surface 75 (FIG. 6B) of the diaphragm 72. The first major surface 75 faces a cavity 73 and the other major surface receives the fluid pressure provided through the port 11. The fluid pressure causes the diaphragm 72 to flex into the cavity 73, which changes the resistance of the piezoresistive elements, which changes the electrical signal output in the wires.

Several components effectively isolate the pressure and temperature cell assembly 71 from forces or pressures other than from the fluid medium applied through the port 11. For example, a ceramic housing 78, a pressure cell fitting 68, a transition ring 70, insulation 80, and a ring 82 act as a protective enclosure for the pressure and temperature cell assembly 71. The components can be welded together or secured by an electron beam weld.

As shown in the cross-sectional view, the wire 76 is threaded in through-hole 88 and the wire 75 is threaded in through-hole 89 in the ceramic cell 74. The wires 75 and 76 continue respectively through a tube 84 and a tube 85 to the wires 91, 17. All of the wires (including wires between and behind the wires 75, 76 in FIG. 4) attached to the diaphragm 72 extend by various conductors to carry the electrical signals a lengthy distance through the housing 16, the conductor tube 26, the transition housing 33, the cable 28, the adapter housing 49, the braided flex 48 to the electronic circuit boards: the pressure circuit 56, the temperature circuit 57, the digital compensation circuit 69, and the RF/EMI filter system in the electronic housing 61 as shown in FIGS. 1-2. This embodiment helps keep the electronic away from deleterious effects from high pressure, high temperature, and/or EMI, e.g., in close proximity to drilling and petrochemical extraction.

In an embodiment, the electronics circuit boards may include a small power source for providing a voltage across the piezoresistive elements. The digital compensation circuit 69 may include an amplifier, compensation circuitry or other circuitry to enhance the signals provided from the pressure sensor assembly 71. For example, the compensation circuitry may receive an input from a temperature sensor and employ a curve fitting algorithm to enhance the accuracy of the transducer over a broad temperature range.

Depending on the specific application, the electronics contained may alternatively be contained in an external electrical monitoring housing (not shown). In this case, electronics housing 61 may be dispensed with.

FIG. 5A illustrates an isometric view of the hexagonal shaped diaphragm with piezoresistive elements and electrical contacts. FIG. 5B illustrates a top view of the hexagonal shaped diaphragm with piezoresistive elements and electrical contacts.

As shown in FIG. 5A-5B, the hexagonal shaped diaphragm assembly 130 includes a sapphire force collector diaphragm 132 with two major surfaces. The first major surface shown is a substrate for piezoresistive elements fabricated using semiconductor processes. The other major surface (not shown) faces the fluid media. In an embodiment, the first major surface 108 is a substrate for depositing a variable compensating resistor 77, a gauge 110, a Wheatstone bridge with arms 118, 120, 122, and 124, and a temperature gauge 112. Contact pads (e.g., contact pad 114) on the first major surface extend from the piezoresistive elements (e.g., contact arm 116) for attaching the wires (e.g., wire 76) by a semiconductor process or solder that carry electrical output signals from the piezoresistive pressure and temperature transducer.

FIG. 6A illustrates an isometric view of the circular shaped diaphragm with piezoresistive elements and electrical contacts. FIG. 6B illustrates a top view of the circular shaped diaphragm with piezoresistive elements and electrical contacts.

As shown in FIG. 6A-6B, the circular shaped diaphragm assembly 106 includes a sapphire force collector diaphragm 72 with two major surfaces. The first major surface 75 functions as a substrate for piezoresistive elements fabricated using semiconductor processes. The other major surface (not shown) faces the fluid media. In an embodiment, the first major surface 75 is a substrate for depositing a variable compensating resistor 77, a gauge 110, a Wheatstone bridge with arms 118, 120, 122, and 124, and a temperature gauge 112. Contact pads (e.g., contact pad 114) on the first major surface 108 extend from the piezoresistive elements (e.g., contact arm 116) for attaching the wires (e.g., wire 76) by a semiconductor process or solder that carry electrical signals from the piezoresistive pressure and temperature transducer.

U.S. Pat. No. 4,994,781 Pressure Sensing Transducer Employing Piezoresistive Elements on Sapphire and U.S. Pat. No. 5,088,329, Piezoresistive Pressure Transducer (Sahagen '781 and '329 patents), are incorporated by reference in their entirety, and describe the process and manufacturing details for making the piezoresistive pressure and temperature transducers that can be used in our system. In particularly, Sahagen '781 and '329 patents describe how to manufacture and operations of the diaphragm assemblies just described and shown in FIGS. 5A-5B and 6A-6B.

FIG. 7 is a schematic of an embodiment of the pressure and temperature sensing circuits with resistive thermal compensation just described and shown in FIGS. 5A-5B and 6A-6B.

FIG. 8A illustrates an end view of an embodiment of pressure cell base. The pressure cell base 74 includes a recess 86 for receiving the circular shaped diaphragm 72, and a set (e.g., ten) of through-holes (e.g., 88 and 89) for wires from the diaphragm 72. The number of through-holes is for the wires (e.g., wire 76) attached to diaphragm 72. Although cavity 73 in the pressure cell base 74 is triangular in shape, it could be any geometric shape (e.g., circular, rectangular, etc.) that leaves an area where the pressure cell base does not support the diaphragm 72. FIG. 8B illustrates a cross-section through line 8B-8B of the pressure cell base, also shows a base layer 90 and a wetted surface 92. FIG. 8C is an isometric of the pressure cell base 74.

FIG. 9A illustrates a perspective view of a multilayered wafer with multiple circular shaped diaphragms before dicing removes each diaphragm from the multilayered wafer using conventional semiconductor techniques.

FIG. 9B illustrates a cross-section of the multilayered wafer. As shown, the multilayered wafer 94 includes a sapphire substrate/diaphragm 96, a silicon sensing element layer 98, a base bonding layer 100, a bonding layer 102, and an insulating layer 104. For brevity, Sahagen '781 and '329 patents describe how to manufacture the multilayered wafer shown in cross-section in FIG. 9B.

FIG. 10A illustrates an end view of a rigid header of the system. As shown the header includes rigid tubes (e.g., 83, 84) secured onto a disk shaped structure made of insulation 80 and ring 82. FIG. 10B illustrates a cross-section through line 10B-10B in FIG. 10A. The header has a circular arranged set (e.g., ten) of tubes (e.g., tubes 83, 84). FIG. 10C illustrates an isometric of the header.

FIG. 11 is a cross-sectional view of the details in the lower part of the transducer housing 16 shown in FIG. 2. As shown in FIG. 11, the lower part of the transducer housing 16 is attached (e.g., welded or bonded) to a pressure fitting 68 with male threads. As shown by FIG. 2, the female threads of protective cone 12 mate thereon. The transition ring 70, the diaphragm 72, the pressure cell base 74 with cavity 73, the ceramic housing 78, the through-hole 88, the insulation 80, the ring 82 are secured together, and were discussed earlier in connection with FIG. 4. A header 15 supports each wire exiting a tube secured to the insulation 80. Each wire (e.g., 76) is preferably made of gold or another conductive material. Ceramic coating 142 covers the inner surface of the transducer housing 16. Welds such as welds 144, 146, and 148 as shown will secure the parts together.

FIG. 12 is a cross-sectional view of the details in the upper part of the transducer housing 20 shown in FIG. 2. As shown in FIG. 12, the upper part of the transducer housing 20 is secured to an adapter ring 14 and to the lower part of the transducer housing 16. In an embodiment, welds 138 and 140 are used to secure the adapter ring 14 to the upper and lower transducer housings 16 and 20. The adapter ring 14 supports a header 15 with a set of integral or secured tubes (e.g., tube 143). A wire (e.g., wire 17) is threaded in each tube (e.g., tube 84). Each wire is connected to other wires (e.g., wire 21). A ceramic coating 142 covers the internal surface of the upper part of the transducer housing 20.

FIG. 13 illustrates a cross-section of the details in the transition housing shown in FIG. 2. As shown in FIG. 13, the transition housing 49 includes a cable soft lead male adapter 44 that slides into the cable soft lead female adapter 42 as indicated by the arrows. A solder joint 41 attaches the Ml Ni wire 34 to a soft lead 43, attached at the opposite end to a multilayered wire 150 (FIG. 14) by a solder joint 46. Braided flex 48 houses the multilayered wire 150 (or e.g., Ml-Ni wire) from the crimped sleeve 47.

FIG. 14 illustrates an embodiment of the multilayered wire 150 suitable for use in one or more parts of the conductive path. In an embodiment, the multilayered wire 150 may constitute the conductive path from the lower transducer housing 16 to the electronic housing 61. On the other hand, the multilayered wire 150 may just be part of that conductive path as described in much of this specification.

As shown in FIG. 14, the multilayered wire 150 is made of conductor 158 (e.g., nickel wire) with a durable multilayered insulation to be described below. Preferably, the conductor 158 is 99.999% pure nickel, 22, 24, or 26 AWG, and fully annealed. The conductor 158 can be obtained from a variety of companies. One suitable source for the conductor 158 is Western Wire, St. Louis, Mo.

The insulation for the multilayered wire 150 is made in the following manner. First, a ceramic coating 155 is applied to the conductor 158. Next, a conventional spray apparatus applies powder coating as the ceramic coating 155. Preferably, the spray apparatus uses dry nitrogen instead of air at about 30 psi to spray on the powder coating. The powder coating is applied liberally until shiny and approximately 0.01-0.02 inches thick. This serves to bind the ceramic coating having approximately 20 micron particles. One suitable powder coating to be used with the dry nitrogen is available from Tech Line Coatings, Inc. 26844 Adam Avenue, Murrieta, Calif. 92562. Thus, after the conductor 158 is braided with the two passes of the double serve fiber to implement a fiber layer, a ceramic coating (e.g., powder coating) is applied as the saturant on the fiber layer. The powder coating cured at room temperate (e.g., 70 F) for 45 minutes, then one hour in an oven at 350 F, then cured for 24 hours in the oven at 500 F.

Next, a single pass double served process adds a fiber layer 156 on the ceramic coating 155. The fiber layer 156 preferably includes 20 micron ceramic or fiberglass fibers. Ceramic coating 154 is then applied on the fiber layer 156 using the same materials and processes used to apply the ceramic coating 155. Further, a fiber layer 152 is applied on the ceramic coating 154 using the same materials and processes used to apply the fiber layer 156. Finally, a ceramic coating 157 is applied on the fiber layer 152 using the same materials and processes used to apply the ceramic coating 155. The multilayered wire 150 can be made as just illustrated, or few layers such as coating/fiber layers 154, 155, and 156. In an alternative embodiment, the multilayered wire can be additional coating/fiber layers beyond that illustrated in FIG. 14 and/or bundled with other multilayered wires for additional strength, insulation and durability.

FIG. 15 illustrates details of embodiments of the electronics housing and the RF/EMI filter housing shown in FIGS. 1-2. As shown in FIG. 15, the electronics housing 61 includes an adapter ring 61 connected to an 8-pin connector 54 (also see FIG. 2). The electronic housing 61 is integral or attached to the filter board housing 62. An operator can rotate a trim potentiometer (pot) screw 58 to adjust the settings on the pressure circuit 56 (FIG. 2) and rotate another trim pot screw 69 to adjust the settings on the temperature circuit 57 (FIG. 2). The RF/EMI filter housing 62 includes an adapter ring 63 connected to a conduit fitting 64. Temperature signal cable 65 and pressure signal cable 66, each with one or more wires, exit from the conduit fitting 64, to be connected to a computer (not shown) for data processing.

FIG. 16A is an end view of the RF/EMI filter board assembly. As shown, the RF/EMI filter board assembly 60 includes a set of filter nuts (e.g., filter nuts 168 and 170) secured in a circular arrangement on filter board 162. Also shown is filter pin 164. The filter board assembly filters undesired RF/EMI noise in each wire attached to a filter nut. A suitable RF/EMI filter board assembly is available from Sensonetics, Inc., 15402 Electronic Lane, Huntington Beach, Calif. 92649.

FIG. 16B is a cross-section through a line along 16B-16B of the RFI/EMI filter board assembly. As shown, the filter board 162 is secured (e.g., silver epoxy 166) in the filter board housing 62. The cross-section is through filter nuts 168 and 170. Also shown is an illustrative filter pin 164 used to secure a wire (not shown).

FIG. 16C is an isometric view of the RFI/EMI filter board assembly 60 including the filter board housing 62, the filter board 162, and the filter pin 164.

FIG. 17 is a cross-sectional view of the K-type thermocouple and Ml cable that can be used for cable 38, and can be obtained from a variety of Ml cable suppliers in the USA. It is used in oil exploration. Another source of the Ml cable and K-type thermocouple is Sensonetics, Inc., 15402 Electronic Lane, Huntington Beach, Calif. 92649. Because it is known, its structure will be briefly discussed. It includes may include a plurality of conductors such as conductors 170 and 176 and conductors 172 and 174 of the K-type thermal couple terminated at joint 178. Each conductor is individually insulated. Insulation can also fill around the conductors inside of cable 38 to further reduce the risk of electrical shorts in the cable 38.

What is claimed:

1. A modular system for sensing fluid properties, comprising:
a piezoresistive transducer that contacts a fluid;
a transducer housing for the piezoresistive transducer;
a conductor tube;
a transition housing;
a cable;
an adapter housing;
a flex conductor;
an electronic housing, wherein the transducer housing, the conductor tube, the transition housing, the cable, the adapter housing, the flex conductor, and the electronic housing protect a conductive path for electrical signal(s) from the piezoresistive transducer to the electronic housing.

2. The modular system of claim 1, wherein the piezoresistive transducer includes a pressure cell base with a cavity, a sapphire force collector diaphragm with a first major surface with piezoresistive element(s) near or over the cavity that bend in response to fluid pressure collected on the other major surface of the sapphire force collector diaphragm.

3. The modular system of claim 3, further comprising a digital compensation circuit in the conductive path to linearize the electrical signal indicating the fluid pressure.

4. The modular system of claim 2, further comprising a pressure circuit in the conductive path in the electronic housing.

5. The modular system of claim 1, wherein the cable coupling the transition housing to the adapter housing is sufficient in length to keep the electronic housing away from the pressure, temperature, and/or RF/EMI zone near the zone of down-hole drilling.

6. The modular system of claim 1, wherein a part of the conductive path is multilayered wire comprised of core conductor encapsulated in ceramic powder coating and braided fiberglass insulation.

7. The modular system of claim 5, wherein the cable is stainless steel to protect the multilayered wire from the environment and coated inside with a ceramic coating to protect the multilayered wire from shorts.

8. The modular system of claim 1, wherein swage lock fittings secure the transducer housing, the conductor tube, and the transition housing together.

9. The modular system of claim 1, wherein crimped sleeves secure the cable, the adapter housing, the flex conductor, and the electronic housing together.

10. The modular system of claim 1, wherein the adapter housing includes a cable soft lead male adapter and a cable soft lead female adapter and a soft lead which is part of the conductive path.

11. The modular system of claim 1, further comprising RF/EMI housing coupled to the electronic housing, and including a RF/EMI filter assembly in the conductive path.

12. The modular system of claim 1, wherein the piezoresistive transducer includes a sapphire force collector diaphragm with a first major surface with a piezoresistive element that senses the fluid temperature.

13. The modular system of claim 12, further comprising a digital compensation circuit in the conductive path to linearize the electrical signal indicating the temperature pressure.

14. The modular system of claim 2, further comprising a temperature circuit in the conductive path in the electronic housing.

15. The modular system of claim 2, further comprising K-type thermocouple wires that extend from adapter housing to the pressure signal cable.

16. The modular system of claim 1, wherein the transducer housing, the conductor tube, the transition housing, the cable, the adapter housing, the flex conductor, the electronic housing are made of stainless steel.

17. The modular system of claim 1, further comprising a protective cone with a fluid port secured to the transducer housing.

18. The modular system of claim 1, wherein each of the transducer housing, the conductor tube, the transition housing, the cable, the adapter housing, the flex conductor, the electronic housing include headers secured to adapter rings, wherein each header is a disc secured to an adapter ring, wherein each header is a disk secured to a set of tubes each supporting a wire in the conductor path.

19. The modular system of claim 2, wherein the sapphire diaphragm is circular or hexagonal in shape and the piezoresistive elements are silicon deposited on the first major surface of the sapphire diaphragm.

20. The modular system of claim 16, further comprising contact pads, wherein the piezoresistive elements include a variable compensating resistor, a gauge, a Wheatstone bridge and a temperature gauge, wherein the contact pads extend from the piezoresistive elements to attach the wires in the conductive path.

21. The modular system of claim 4, further comprising a trim pot pressure screw to adjust the settings on the pressure circuit.

22. The modular system of claim 14, further comprising a trim pot temperature screw to adjust the settings on the temperature circuit.
